(19) United States
(12) Patent Application Publication
(10) Pub. No.: US 2004/0048534 A1
(43) Pub. Date: Mar. 11, 2004

(54) Nonwoven material for infusion convenience packaging application

(76) Inventors: Helen Viazmensky, Avon, CT (US); Charles Fay, Windsor Locks, CT (US)

Correspondence Address: ALIX YALE & RISTAS LLP, 750 MAIN STREET, SUITE 1400, HARTFORD, CT, 06103, US

(21) Appl. No.: 10/470,233

(22) PCT Filed: Jan. 31, 2001
(86) PCT No.: PCT/US01/03091

(51) Int. Cl. B32B 5/18

(52) U.S. Cl. 442/76; 442/327; 442/414

(57) ABSTRACT

Disclosed is a wet laid, nonwoven web material having stiffness and infusion properties suitable for use as an infusion convenience package. The web material is suitable for use with conventional high speed automated packaging and heat sealing equipment. The web material may also be hydrophobic and comprise thermoplastic material.

### FIELD OF THE INVENTION

The present invention relates generally to wet laid nonwoven web material. It is more particularly concerned with new and improved wet laid nonwoven web material having properties adapted for use in manufacture of infusion convenience packages using conventional heat sealing equipment.

### BACKGROUND OF THE INVENTION

Infusion packages for brewing beverages, such as tea bags and coffee bags, are generally produced by sealing beverage precursor materials within a porous web material. The infusion package is either placed in a cup or pot containing hot water, or alternatively, the infusion package is placed in an empty cup or pot and subsequently hot water is added. In either event, the hot water passes through the web material into the bag to extract the beverage precursor materials and the extract passes outwardly of the bag to form the brew.

Infusion packages are generally made of fibrous non-woven web materials that are free from perforations or punctures yet possess a high degree of porosity. Particularly favored for infusion packages have been those wet laid, fibrous, nonwoven web materials made on inclined wire paper making machines using long natural fibers. These web materials are generally soft, tissue-thin, low basis weight fibrous materials characterized by their superior rapid and thorough infusion characteristics. As would be expected, such tissue thin web materials have very little intrinsic stiffness.

While it is desirable for the infusion package to allow rapid and thorough extraction of the beverage precursor materials, physical release of the solid beverage precursor materials from the sealed infusion package into the cup is undesirable. To prevent movement of solid beverage precursor materials from the sealed infusion package into the brewing container the porosity and “sifting” characteristics of the nonwoven web material are carefully controlled.

Infusion packages are typically manufactured on highly automated, high-speed packaging and sealing equipment. Typically the manufacturing process comprises drawing web material into the equipment to form spaced layers. A desired amount of a beverage precursor material is placed between the layers and the layers are sealed around the precursor material. Infusion package seals may be of either the “heat seal” or “mechanical crimp” variety. Nonwoven web material suitable for heat sealing applications generally comprises two or more layers or phases. The top or heat seal phase typically includes a high percentage by dry weight of fusible polymeric fibers. The base phase is typically comprised of substantially non-fusible cellulosic materials. In use, the web material is arranged in spaced layers so that the top phases containing the fusible fibers are facing. The spaced layers of web material pass between heated, opposing, movable surfaces such as dies, jaws or rollers. Movement of the heated surfaces toward each other provides the required pressure and heat to the now touching web material faces to flow and fuse the touching fusible fibers therein and create a heat seal seam joining the two layers of web material, sealing the precursor material within. Importantly, the seam retaining the beverage precursor materials within the infusion package must maintain integrity during use to prevent opening of the infusion package and the subsequent undesirable discharge of beverage precursor materials into the brew.

The non-fusible surface of the base phase functions to prevent buildup of the melted polymeric fibers to the heated surfaces of the sealing equipment. It is important that the heated surfaces remain free of adherent polymeric fibers to ensure proper function of the packaging and sealing equipment.

Surprisingly, the high speed automated packaging and sealing equipment that is used with nonwoven heat sealable web materials has been found to operate best within limited ranges of web material thickness and stiffness. Thus, infusion web material must have a minimum combination of basis weight, stiffness, heat fusing ability on one face and lack of heat fusing ability on the opposing face to permit use on automated equipment. Infusion web material must have a further minimum combination of water permeability, porosity, sifting and infusion properties to be acceptable for use as infusion packaging.

As used herein, the term “infusion convenience package” refers to an infusion package having a handle portion attached to a pouch portion. The handle portion is substantial enough so that a user can move or “stir” the infusion package around the container during brewing. An infusion convenience package of this type is useful in reducing the typical brewing time of three to five minutes to thirty seconds or less. Additionally, such a package is beneficial with precursors such as dried soup mixes that infuse at a slower rate than coffee or tea. Naturally, the stiffness of the web material that allows handling of an infusion convenience package must not interfere with the minimum combination of properties required for successful infusion use. The prior art has not yet addressed the need for a web material suitable for production of infusion convenience packages on conventional high-speed automated packaging and sealing equipment.

U.S. Pat. No. 1,489,806 to Anderson teaches an infusion package made from perforated material. U.S. Pat. No. 2,192,605 to Salfisberg teaches a porous infusion package attached to a non-porous handle. U.S. Pat. Nos. 2,562,456 and 4,605,123 each teach the application of a flexible strip to the infusion package for squeezing residual fluid from the package. U.S. Pat. Nos. 3,797,642, 4,699,794 and 4,806,369 each teach the addition of a rigid, non-fibrous handle to the infusion package. Each of the above references requires the provision of non-infusion web material to act as a handle, complicating the manufacturing process. U.S. Pat. No. 2,413,686 to Barnett recognizes the problems inherent in the above references and teaches an infusion package wherein a portion of the infusion web material seam area is detachable to form a handle. However, the Barnett reference is not completely satisfactory in that the handle portion is limited to the thin, seamed areas and the web material itself is not truly stiff enough to form a useful handle portion but is rather an attempt to replace the common infusion package “string and tab”.

### SUMMARY OF THE INVENTION

One aspect of the invention provides a multiple phase, fibrous nonwoven web material having a basis weight in the range of 10 to 100 grams per square meter (gsm). Preferably the web material has a basis weight in the range of 24 to 50 gsm. The inventive web material may be wet laid. The inventive web material comprises less than 50 percent of a latex binder having a high glass transition temperature (Tg) in the range of 10 to 120° C. Preferably the inventive web material comprises less than 20 percent of a latex binder having a high Tg in the range of 80 to 110° C. The basis weight and high Tg latex binder function together to provide a nonwoven web material having sufficient stiffness to allow stirring of an infusion convenience package made therefrom. Advantageously the inventive web material has a Gurley stiffness in the range of 10 to 110 mg and preferably the inventive web material has a Gurley stiffness in the range of 50 to 75 mg.

Another aspect of the invention provides a two phase, fibrous nonwoven web material as described above wherein one phase comprises more than 25 percent thermoplastic material and the second phase joined thereto comprises predominately non-thermoplastic material. The material of this embodiment is adapted for use with conventional, automated, high speed packaging and heat sealing equipment.

A further aspect of the invention provides a multiple phase, fibrous nonwoven web material as described above comprising a hydrophobic latex binder to lessen water wicking of the web material. Advantageously the web material of this aspect has a hot water wicking result of less than 10 mm and preferably a hot water wicking result of about 0 mm.

Yet another aspect of the invention provides a multiple phase, fibrous nonwoven web material as described above. In this embodiment the web material is textilized to provide areas of locally reduced basis weight thereby enhancing infusion characteristics while maintaining low sift values. Preferably the web material of this embodiment has a first color time of less than 10 seconds and a percent transmittance of less than 75 percent.

The inventive nonwoven web material overcomes the above described problems of the prior art and achieves enhanced stiffness, lessened hot water wicking and good infusion characteristics. The characteristics of the inventive web material make it especially suited for use in manufacturing infusion convenience packages. Infusion convenience packages consisting essentially of a beverage precursor sealed within the inventive web material are sufficiently stiff to allow unassisted stirring by a user; have low hot water wicking to prevent the boiling water from reaching the user's fingers and to maintain stiffness after immersion therein; and have porosity properties suited for acceptable infusion of the beverage precursor extract into the hot brew. Additionally, the stiffness, basis weight and composition of the inventive nonwoven web material allows production of infusion convenience packages using conventional high speed packaging and sealing equipment.

It is an object of the present invention to provide a new and improved web material suitable for use on conventional heat and pressure type sealing equipment.

It is another object of the invention to provide a web material that can be processed on conventional heat and pressure type sealing equipment to form an infusion package of enhanced stiffness.

It is a further object of the invention to provide a web material that retains the desirable porosity and infusion characteristics of conventional heat seal infusion web materials while providing increased stiffness and hydrophobicity.

It is yet another object of the invention to provide a new and improved web material suitable for manufacture of an infusion convenience package using conventional heat and pressure type sealing equipment.

It is still another object of the invention to provide a method of manufacturing a new and improved web material suitable for manufacture of an infusion convenience package using conventional heat and pressure type sealing equipment.

A better understanding of the invention will be obtained from the following detailed description of the article and the desired features, properties, characteristics, and the relation of the elements as well as the process steps, one with respect to each of the others, as set forth and exemplified in the description and illustrative embodiments.

### DETAIL D DESCRIPTION OF THE PR F RRED EMBODIMENT

Broadly, one aspect of the present invention comprises a heat sealable, nonwoven web material comprised of natural and synthetic fibers. The inventive web material exhibits increased stiffness compared to conventional heat sealable web materials. The inventive web material is sufficiently stiff so that a user can stir an infusion convenience package produced entirely therefrom, both infusion pouch portion and attached handle portion, using only the handle portion. Preferably, the inventive web material has a Gurley stiffness of at least 10 mg. Surprisingly, in view of the increased stiffness, the inventive web material has acceptable infusion properties.

The inventive web material of this aspect comprises a wet laid nonwoven material having two phases or layers, a base phase and a top phase. The top phase comprises thermoplastic materials and functions as a fusing layer under application of heat and pressure. The base phase comprises predominately cellulosic materials and functions to provide an insulating or non-fusing layer. It should be understood that the terms “top phase” and “base phase” are used in this specification for identification only and are not intended to refer to manufacturing sequence or finished material orientation unless otherwise explicitly stated.

The base phase comprises predominately cellulosic materials. Advantageously, the base phase comprises at least 75 percent cellulosic material and may comprise up to 25 percent synthetic materials. Preferably the base phase comprises 75 to 100 percent natural cellulosic material.

The predominant natural fibers utilized in the inventive web materials may be any of the well known natural paper making fibers or mixtures thereof. They preferably include long natural fibers such as jute, abaca, sisal, hemp, kenaf and mixtures of the above. These long natural fibers are substantially uniform in length, varying from 2 to 7 millimeters (mm) and are substantially free of minute fibers. The long fibers are relatively cylindrical, are slightly tapered and have little tendency to curl or twist when dispersed in solution. Shorter wood fibers, such as bleached or unbleached kraft, may also be used, either alone or in combination with other fiber types.

The top phase comprises cellulosic and synthetic materials. Advantageously the top phase comprises 90 to 10 percent cellulosic material and 10 to 90 percent synthetic materials. Preferably the top phase comprises 70 to 80 percent natural cellulosic material and 30 to 20 percent synthetic materials. The top phase synthetic materials are thermoplastic synthetic fibers of any type commonly used in papermaking applications, including, for example, bicomponent and biconstituent fibers. Alternatively the top phase synthetic materials can comprise about 70 to 30 percent thermoplastic fibers and about 30 to 70 percent synthetic thermoplastic pulp. The top phase has a basis weight in the range of 3 to 20 gsm. Advantageously the top phase may have a basis weight in the range of 4 to 12 gsm and preferably in the range of 6 to 8 gsm.

The synthetic materials comprising the top phase include thermoplastic polymers, for example, polyolefins and may include non-thermoplastic polymers. The thermoplastic polymers function to allow fusion of contacting top phases under application of heat and pressure. The synthetic materials may include those with fiber morphologies of synthetic shortcut fibers, synthetic pulps or mixtures thereof. The synthetic fibers exhibit conventional smooth cylindrical or rod-like morphology with low specific surface area. Synthetic fibers have typical lengths of 1-25 mm, typical denier of 0.5-15 and typically low surface areas. Synthetic fibers are usually formed by a process such as melt spinning.

The synthetic pulps are synthetic thermoplastic materials, such as polyolefins, having a structure more closely resembling wood pulp than synthetic fibers. That is, they contain a micro-fibrillar structure comprised of micro-fibrils exhibiting a high surface area as contrasted with the smooth, rod-like morphology of conventional synthetic fibers. The synthetic thermoplastic pulp-like material can be dispersed to achieve excellent random distribution throughout the aqueous dispersing media in a papermaking operation and, consequently, can achieve excellent random distribution within the resultant web material. The pulps found particularly advantageous in the manufacture of infusion web materials are those made of the high density polyolefins of high molecular weight and low melt index.

The fibrils can be formed under high shear conditions in an apparatus such as a disc refiner or can be formed directly from their monomeric materials. Patents of interest with respect to the formation of fibrils are the following: U.S. Pat. Nos. 3,997,648; 4,007,247; and 4,010,229. As a result of these processes, the resultant fibril dispersions are comprised of thermoplastic polymer particles having a typical size and shape comparable to the size and shape of natural cellulosic fibers; and such particles are commonly referred to as “synthetic pulp. The pulp particles exhibit an irregular surface morphology or structure that comprises fibrils which in turn are made up of micro-fibrils, all mechanically inter-entangled in random bundles generally having a width in the range of 1 to 20 microns (μ). The pulp particles have a surface area in excess of one square meter per gram, and may have surface areas of even 100 square meters per gram. In general, the pulp-like fibers of polyolefins such as polyethylene, polypropylene, and mixtures thereof have a fiber length well suited to the paper-making technique, e.g., in the range of 0.4 to 2.5 mm with an overall average length of about 1 to 1.5 mm.

Numerous different techniques have been employed to make multi-phase fibrous webs. Typical of those techniques found useful in the production of multi-phase web materials is the dual head box technique described in U.S. Pat. No. 2,414,833. In accordance with that process the fibers for each phase are mixed into a fluid to form a dilute slurry or furnish. The first furnish flows through a primary head box and continuously deposits as a bottom layer or base phase on an inclined, web forming wire screen. The second furnish for the top layer or second phase is introduced into the primary head box at a location immediately after or at the point of deposition of the base phase on the inclined wire screen. This may be carried out by means of an inclined trough or by a secondary head box in such a manner that the top phase fibers commingle slightly with the base phase fibers flowing through the primary head box. In this way, the base fibers have a chance to provide a base mat or phase, prior to the deposition of the second or top phase. As can be appreciated, the top phase is secured to the base phase by an interface formed by the intermingling of the fibers within the aqueous suspension. Typically, nonwoven web materials produced in this manner have the first phase covering the entire area of the web surface in contact with the inclined wire screen while the opposing side of the web has a mixture of fibers with the top phase fibers greatly predominating. In this way there is not a clear line of demarcation between the phases of the multi-phase sheet materials; yet there is a predominance of top phase fibrous material on one surface or top phase of the multi-phase sheet. The center or interface boundary is, of course, composed of a mixture of the two different types of fibers. It should be appreciated that the invention also covers web materials comprising three or more layers.

The wet laid web material is subjected to a conventional drying step to reduce water present in the formed web. The drying step may comprise vacuum drying, passage around heated drying cylinders, passage through heated dryers or combinations of the above.

It should be noted that heat sealable type web materials typically undergo an additional heated fusing step subsequent to the drying step to fully “activate” the synthetic fibers. As used herein, activation refers to the imposition of energy to a substance so that the substance will undergo subsequent chemical or physical change more rapidly or completely.” The inventive web materials in any embodiment may incorporate additional materials or processes as conventionally understood and used in the papermaking art.

For ease of understanding and clarity of description, the inventive nonwoven web material is below described in its application to heat sealable, porous, infusion web materials for use in the manufacture of infusion convenience packages and the like. In a preferred embodiment the infusion convenience package is formed from two sheetlike sections of the inventive web material fused together around a beverage precursor material. The inventive web material is sufficiently stiff so that an infusion convenience package produced entirely therefrom, both infusion portion and attached handle portion, may be pushed or rotated around the brewing container by a user manipulating the handle portion. Advantageously the inventive web material has a Gurley stiffness of at least 10 mg. Preferably the inventive web material has a Gurley stiffness in the range of about 10 to 110 mg. More preferably the inventive web material has a Gurley stiffness in the range of about 50 to 75 mg. As us d herein, Gurley stiffness refers to the Gurley procedure described in TAPPI T543 (OM-94). A Gurley stiffness tester model 4171D available from Teledyne Gurley has been found suitable for the above testing.

The stiffness of the inventive web material is partially a function of its basis weight and partially a function of treatment with a high Tg binder as described below. As the basis weight of the web material is increased, the stiffness will also increase. The inventive web material has a basis weight in the range of about 10 to 75 gsm. Advantageously the inventive web material may have a basis weight in the range of about 20 to 50 gsm. Typically the basis weight is about 30 to 40 gsm.

The inventive web material is treated throughout its extent with a relatively high Tg binder material which, when set or cured, is insoluble in aqueous solutions and unaffected by boiling water. The binder must provide not only increased strength and stiffness, but must also provide this property without adversely affecting the desirable infusion characteristics of the treated web material. Additionally, the binder material utilized according to the invention should exhibit an affinity for being readily absorbed into the fibers of the web material while substantially retaining the porosity of the web. Accordingly, the materials used herein are distinguished from materials that form high solid films over the treated area. Advantageously, the binder system has a high glass transition temperature within the range of about 10 to 120° C. Preferably, the binder system has a glass transition temperature within the range of about 90 to 100° C.

The binder materials found to be particularly effective are the materials generally categorized as carboxylated polystyrene dispersion polymers. These materials are preferred due to their high Tg and ability to substantially permeate the filaments or fibers of the web material without blocking or interfering with the porous openings between fibers. Styrofan NX 9950 X available from BASF of 11501 Steele Creek Road, Charlotte, N.C. has been found suitable for use in the invention. Naturally, other binder materials providing desired stiffness characteristics to the web material, such as, for example, acrylic, SBR or PVA materials, would also be useful in the invention and are encompassed therein.

The binder material may be applied to the preformed infusion web material by well-known techniques used to add such materials while ensuring complete coverage of the web material. For example, the web material may be treated by brush, roller, spray or immersion bath to effectuate the desired binder material application to the web material. Since complete impregnation of the web material is desired, a saturation treatment is preferred. The latex binder emulsions generally penetrate quickly through the rather thin and absorbent web material and may be applied during a suitable stage in the manufacture of the fibrous web material. For example, in a conventional papermaking machine, a saturating size press containing the binder material may be placed adjacent the dryer section prior to the final drying and collection of the web material. After treating the web material with the latex dispersions of the binder material, which very quickly permeates through the entire thickness of the web material, the treated web material is subjected to a thermal or heat cure in order to set the binder prevent leaching therefrom. This operation may be combined with the normal drying steps employed in making the nonwoven web material. Although the latex binders may be air dried since they are self-curing, heat curing during the drying operation is preferred.

The latex binder material may be applied in undiluted form or may be diluted with water to provide the desired binder concentration, viscosity and pick up by the web material during application. The latex binder should be applied so that the finished web material may have a binder loading, within the range of about 1 to 50 percent of the final web material basis weight. Preferably the finished web material has a binder loading within the range of 15 to 20% of the final web material basis weight.

It should be realized that every nonwoven web material is not suited for use in infusion packaging. Acceptable infusion packages must have a minimum combination of water permeability, porosity and infusion properties. Typically, an infusion package prepared from a web material having a basis weight of about 14 gsm has a quiescent first color time of less than about 13 seconds and a quiescent first color time of less than 10 seconds is preferred. A quiescent first color of about 5-7 seconds is considered indicative of superior infusion characteristics for an infusion package prepared from web material having a basis weight of about 14 gsm. Of course, infusion packages prepared from thicker, heavier basis weight materials typically have higher and less desirable quiescent first color values than packages prepared from lighter basis weight materials. Another target value for good infusion is a % transmittance in the mid-sixty percentile range with transmittance decreasing as infusion improves.

Advantageously, an infusion convenience package prepared using the inventive web material has a quiescent first color time of less than 13 seconds. Preferably the infusion package has a quiescent first color time of less than 10 seconds. Quiescent first color time is determined by placing an infusion package formed of the inventive web material just below the surface of 250 ml of still, freshly boiled water. The time at which the initial amber stream (first color) can be seen fusing from the bag surface into the water is the quiescent first color time in seconds.

An infusion package prepared using the inventive web material has a quiescent % transmittance of less than about 75 percent. To test for quiescent % transmittance the sample infusion package is allowed to stand in the same hot water used for the quiescent first color testing for a total time of 60 seconds, after which the sample infusion package is removed. Upon cooling of the infused water to room temperature, the solution is measured using a calorimeter set at a wavelength of 535 nm and a 1 cm optical path cell.

The above quiescent first color time and % transmittance values may not be as good as is typically found for conventional infuser web materials. However, an infusion convenience package prepared from the inventive web material may conveniently be agitated by a user rotating or pushing the infusion pouch portion within the brewing container using the handle portion. This agitation substantially decreases the first color time. To simulate such agitation an agitated first color test is used wherein 250 ml of freshly boiled water is poured into a 400 ml beaker. A 1.5 inch by 0.25 inch stir bar is placed in the beaker and the beaker is placed on a stir plate. The stir plate is adjusted to allow maximum stir bar rotation without formation of a vortex in the water. Typically, an adjustment of 70 to 75 revolutions per minute is satisfactory. Agitated first color time is determined by placing an infusion package formed of the inventive web material just below the surface of the moving water. The time at which the initial amber stream (first color) can be seen fusing from the bag surface into the moving water is the agitated first color time in seconds. To test for agitated % transmittance, the sample infusion package is allowed to stand in the same moving hot water used for the agitated first color testing for a total time of 60 seconds, after which the sample infusion package is removed and stirring is stopped. Upon cooling of the infused water to room temperature, the solution is measured using a colorimeter set at a wavelength of 535 nm and a 1 cm optical path cell. An infusion package prepared using the inventive web material has an agitated color time of less than about 4 seconds and an agitated % transmittance of less than about 75 percent. Preferably, an infusion package prepared using the inventive web material has an agitated color time in the range of about 2 to 4 seconds and an agitated % transmittance of less than about 65 percent.

In another aspect of the invention the formed web material is “textilized”. Textilizing a nonwoven web material allows a web material to have an increased basis weight, and thereby increased stiffness, while retaining the desirable infusion characteristics of a lighter and less stiff web material. Textilization is used to provide repeating unit areas of the web material with a locally reduced basis weight. The textilized areas function to enhance infusion properties of the web material. U.S. Pat. No. 4,666,390 describes an embodiment of a textilization process wherein controlled streams or jets of fluid are sprayed at a pressure onto selected areas of the wet laid web material prior to the drying operation. A rotating member having apertures therein is disposed between the fluid jets and the web material. The rotating member controls the textilization process allowing selective impingement of the fluid jet against the web material only when an aperture of the rotating member is aligned with the fluid jet nozzle. The shape and size of the member apertures and the rotational speed of the member function to control the shape, size and length of time the fluid jet impinges on the web material. Impingement of the fluid jet against the wet web deforms the surface of the wet web by moving a percentage of the fibers in the impact zone to surrounding areas. As expected, variations in fluid jet pressure and vacuum level at the fluid removal slot affect displacement of fibers in the impact zone. The above result in a localized region of the web material having a lower basis weight than the surrounding regions. As one example, the web may be textilized in a “light diamond” pattern (LD). The diamonds have dimensions of 1/16 inch by ⅛ inch with 63 indentations for each square inch of web material. The light diamond pattern can be calculated to provide 50 percent of the web material with a reduced basis weight. Another example is a “Daisy” pattern (DP) that can be calculated to have about 48 percent open area. Naturally, other patterns providing other percentages of reduced basis weight could be used to achieve desired infusion results.

In another aspect of the invention of the web material is impregnated throughout its extent with a hydrophobic agent. As used herein the term “hydrophobic” refers to the characteristic of the treating agent that imparts to the treated web material a resistance to, or the ability to avoid, wetting with water. The hydrophobic agent imparts an aversion to or lack affinity for water and resists the passage of liquid water into the structural components of the web material through capillary action. Hydrophobicity is especially important in an infusion convenience package as it prevents on the hot water of the brew from being wicked into the handle portion where it will undesirably contact the user's fingers. Further the web material hydrophobicity functions to maintain the stiffness of the handle portion during immersion of the infusion convenience package in the hot water. Naturally, for an infusion web material, the hydrophobic agent must impart hydrophobicity to the web material without interfering with the desirable infusion characteristics.

The hydrophobic character of the nonwoven web material is best measured by its “wicking” and the absence of such wicking is a primary indicator of its hydrophobic character. A wicking test is a measure of the rate at which the web material absorbs water by capillary action. In accordance with the wicking test, a web material sample is cut into a 1 inch by 5 inch strip. The strip is attached to a support bar and placed over a beaker containing freshly poured hot water. The web material sample is adjusted so that 0.5 to 0.75 inches of the sample strip are immersed in the hot water. The position of the water surface on the sample is considered to be the start point. The sample is allowed to stand in the hot water for 1 minute, after which time the sample is removed. The wicking result is determined by measuring the length in mm that the hot water climbed or wicked above the start point in the 1-minute test period. Although wicking may be tested in either hot or cold water, since hot water is typically used to brew beverages, the hot water value is particularly relevant for this application. Advantageously, the inventive web material has a hot water wicking value of less than about 15 mm. Preferably, the inventive web material has a hot water wicking value as close to zero as possible. The hydrophobic agents may be applied as described above. Surprisingly, Styrofan NX 9950 X available from BASF not only acts as a binder material to impart strength and stiffness but also simultaneously acts as a hydrophobic agent.

An especially preferred aspect of the invention comprises a wet laid, two-phase, heat sealable, nonwoven web material comprising a hydrophobic latex binder. The nonwoven material of this embodiment advantageously has as a basis weight in the range of about 24 to 50 gsm and a Gurley stiffness in the range of about 50 to 75 mg. In this embodiment the nonwoven web material is textilized sufficiently to maintain the desired infusion properties of a quiescent first color time of less than 10 seconds and a quiescent percent transmittance of less than 75%. While this inventive web material has both a basis weight and stiffness greater than traditionally used for infusion web materials it is still suitable for production of infusion packages on conventional automated high-speed packaging and sealing machinery. Further, the preferred web material has sufficient stiffness and infusion properties to produce an entire infusion convenience package, including the handle portion and the infusion portion, using conventional automated high-speed packaging and sealing equipment with only minor adjustments to accommodate the infusion convenience package shape.

Another aspect of the invention relates to an infusion convenience package comprising two layers of a nonwoven web material enclosing a beverage precursor and having an attached portion of the same web material that functions as a handle. The nonwoven web material comprises two phases and has a basis weight in the range of 10 to 100 gsm; a Gurley stiffness in the range of 10 to 110 mg; a quiescent first color time of less than 10 seconds and a quiescent percent transmittance of less then 75%. Advantageously, the nonwoven web material of this aspect comprises less than 50% of a hydrophobic, high Tg binder material and has a wicking value of less than about 10 mm.

Having generally described the invention, the following examples are included for purposes of illustration so that the invention may be more readily understood and are in no way intended to limit the scope of the invention unless otherwise specifically indicated.

### EXAMPLE 1

A series of textilized nonwoven web materials were prepared at various basis weights and textilization patterns. The general procedure for preparation of the nonwoven web materials was as follows.

A base phase slurry or furnish was prepared by adding 52 lbs. of wood pulp (based on dry solids) and 300 gal. of water to a beater/refiner. The solution was brushed for 10 minutes after which 13 lbs. of hemp (based on dry solids) was added to the solution and brushing was continued for an additional 15 minutes. Upon completion of the second brushing operation 1500 ml of a wet strength resin comprising an aqueous solution of cationic amine polymer epichlorohydrin adduct and 1,400 gal. of water was added to the solution to form the base phase furnish.

A top phase slurry was prepared by adding 9 lbs. of wood pulp (based on dry solids), 9.5 lbs. of polyethylene pulp (based on dry solids) and 300 gal. of water to a beater/refiner. The mixture was brushed for about 15 minutes after which 1500 ml of a wet strength resin comprising an aqueous solution of cationic amine polymer epichlorohydrin adduct; 22.5 lbs. of 5 mm polypropylene fibers; 800 ml of a water based detackifying agent; and 1,400 gal. of water was added to the solution to form the top phase furnish.

The two phase nonwoven web materials were wet laid using a two phase headbox onto the forming wire of an inclined wire papermaking machine. The flow rate of the top phase furnish comprising the heat seal fibers was adjusted to provide a layer having a basis weight in the range of between 7.0 and 7.5 gsm while the base phase furnish flow rate was adjusted to provide the desired basis weight for the resulting web material. Textilization was performed at the end of the papermaking machine forming wire by the mechanical action of water sprays against the top phase of the formed web. Latex binder was applied to the already formed nonwoven web material after the first dryer section using a conventional size press operation. The concentration of the latex binder was adjusted by dilution with water to provide the desired pick up level in the nonwoven web material. The latex binder used was Styrofan NX 9950 X from BASF in all cases.

Inventive samples 1-5 were produced using the above procedure and tested for properties, which properties are listed in TABLE 1. Samples 1, 2, 4 and 5 were textilized at a fluid jet pressure of about 60 psi and using about 11 inches of vacuum at the water removal slot. Inventive sample 3 was textilized at a fluid jet pressure of about 40 psi and using about 5 inches of vacuum at the water removal slot. Inventive sample 3 was not effectively textilized as the very low fluid jet pressure and vacuum used was not sufficient to result in displacement of the web material fibers. Consequently the infusion properties of inventive sample 3 are not adequate for production of infuser convenience packages.

Comparative samples A-G represent different conventional nonwoven web materials for comparison purposes. The properties of comparative samples A-G are also listed in TABLE 1. The web material of comparative sample A was treated with a hydrophobic, low Tg, alkyl acrylate binder that substantially prevents water wicking. Despite comparative sample A having the desired minimal wicking properties, the low Tg of the hydrophobic binder combined with the low basis weight of the web material combined to provide a product that did not provide the stiffness necessary to form an acceptable infusion convenience package. Comparative samples B and C are web materials as typically used in infusion package applications. Neither of comparative samples B or C was treated with a hydrophobic material. Comparative samples B and C have poor (excessive) wicking and poor stiffness properties and are not suited to form an acceptable infusion convenience package. Comparative samples D-G are conventional nonwoven web materials as typically used in wiping applications. The web materials of comparative samples D-G have not been treated with a hydrophobic binder. Comparative samples D-G have adequate stiffness properties to form an acceptable infusion convenience package, however their poor wicking properties and poor quiescent infusion properties are not acceptable for that use. As would be expected, the agitated infusion properties of comparative samples D-G were superior to their quiescent infusion properties.

TABLE 1

| | | | | | hot water | Gurley | | | | |
|---|---|---|---|---|---|---|---|---|---|---|
| | basis weight | basis weight | | | wicking | stiffness | standard | standard | agitated | agitated |
| | web only | web + binder | textilized | hyrophobic | MD | MD | 1^{st} color | % T | 1^{st} color | % T |
| sample | (gsm) | (gsm) | pattern | material | (mm) | (mg) | (sec) | (%) | (sec) | (%) |
| A | | 12.3 | none | *1 | 0.0 | 4.8 | 6.8 | 65.1 | 4.0 | 61.0 |
| B | | 16.5 | diamond | none | 25.0 | 6.3 | 6.4 | 65.1 | 1.2 | 58.2 |
| C | | 16.5 | none | none | 26.8 | 7.1 | 8.3 | 66.5 | 1.6 | 59.8 |
| D | 45.0 | — | none | none | 72.3 | 71.9 | 14.6 | 83.8 | 4.2 | 80.0 |
| E | 55.0 | — | none | none | 75.3 | 85.1 | 15.8 | 85.6 | 2.8 | 77.4 |
| F | 55.0 | — | none | none | 90.3 | 34.4 | 9.4 | 77.1 | 2.5 | 67.4 |
| G | 38.0 | — | none | none | 83.0 | 36.5 | 10.9 | 84.2 | 1.6 | 71.0 |
| 1 | 24.0 | 30.0 | DP | 9950 | 0.0 | 11.2 | 9.1 | 73.5 | 4.1 | 69.1 |
| 2 | 34.0 | 40.0 | DP | 9950 | 0.0 | 36.2 | 9.7 | 70.0 | 3.6 | 65.8 |
| 3 | 52.0 | 63.0 | DP | 9950 | 0.0 | 108.2 | 54.5 | 99.3 | 11.3 | 86.7 |
| 4 | 24.0 | 30.0 | LD | 9950 | 0.0 | 18.6 | 9.1 | 71.9 | 2.9 | 63.5 |
| 5 | 34.0 | 40.0 | LD | 9950 | 0.0 | 40.0 | 7.3 | 71.6 | 2.8 | 63.3 |

*1 latex emulsion of alkyl acrylate polymer

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and scope of the present invention.

What is claimed:

1. A wet laid, nonwoven web material having a basis weight in the range of 10 to 100 grams per square meter, a Gurley stiffness in the range of 10 to 110 mg and properties suitable for use as infusion packaging.

2. The web material of claim 1 having a basis weight in the range of 0.24 to 50 gsm.

3. The web material of claim 1 having a Gurley stiffness in the range of 50 to 100 mg.

4. The web material of claim 1 having a first color time of less than 10 seconds and a percent transmittance of less than 75 percent.

5. The web material of claim 1 comprising 1 to 50 percent of a hydrophobic latex binder, the binder having a Tg in the range of 10 to 120° C.

6. The web material of claim 1 comprising 10 to 30 percent of a hydrophobic latex binder, the binder having a Tg in the range of 80 to 110° C.

7. The web material of claim 1 having a wicking value of less than 10 mm.

8. The web material of claim 1 having a first face comprising more than 25 percent thermoplastic material and an opposing face comprising less than 25 percent thermoplastic material.

9. A hydrophobic, wet laid, nonwoven web material including a first phase comprising more than 25 percent by dry weight thermoplastic material, a second phase joined to the first phase, the second phase substantially comprising cellulosic material, and 1 to 50 percent of a binder, the binder having a Tg in the range of 10 to 120° C., wherein the web material has a basis weight in the range of 10 to 100 grams per square meter, a Gurley stiffness in the range of 10 to 110 mg, a first color time of less than 10 seconds and a percent transmittance of less than 75 percent.

10. The web material of claim 9 having a wicking value of less than 10 mm.

11. The web material of claim 9, wherein a portion of a surface has been textilized and has a basis weight lower than the remaining surface.

12. The web material of claim 9, wherein about one half of a surface has been textilized and has a basis weight lower than the remaining surface.

13. An infusion package having a pocket enclosing a beverage precursor wherein the pocket comprises a hydrophobic, wet laid, nonwoven web material including a first phase comprising more than 25 percent by dry weight thermoplastic material, a second phase joined to the first phase, the second phase substantially comprising cellulosic material, and 1 to 50 percent of a binder, the binder having a Tg in the range of 10 to 120° C., wherein the web material has a basis weight in the range of 10 to 100 grams per square meter, a Gurley stiffness in the range of 10 to 110 mg, a first color time of less than 10 seconds and a percent transmittance of less than 75 percent.

14. The infusion package of claim 13 having a handle attached to the pocket.

15. The infusion package of claim 13 having a handle attached to the pocket wherein the handle is comprised of the same nonwoven web material as the pocket.

16. The infusion package of claim 13 having a handle attached to the pocket wherein the handle is comprised of a material that is porous and hydrophobic.

17. The infusion package of claim 13 having a handle attached to the pocket wherein the handle does not wick water when the pocket is immersed in hot water.

18. The infusion package of claim 13 having a handle comprised of the nonwoven web material attached to the pocket, wherein the web material first phase of the handle is fused substantially completely.

19. The infusion package of claim 13 consisting essentially of a first sheet of the web material fused to a second sheet of the web material and enclosing a beveraqe precursor therebetween.

20. An infusion package comprising a pouch portion enclosing a beverage precursor material and a handle portion attached to the pouch portion wherein the pouch portion and the handle portion consist essentially of a hydrophobic, wet laid, nonwoven web material including a first phase comprising more than 25 percent by dry weight thermoplastic material, a second phase joined to the first phase, the second phase substantially comprising cellulosic material, and 1 to 50 percent of a binder, the binder having a Tg in the range of 10 to 120° C., wherein the web material has a basis weight in the range of 10 to 100 grams per square meter, a Gurley stiffness in the range of 10 to 110 mg, a first color time of less than 10 seconds and a percent transmittance of less than 75 percent.
